(19) United States
(12) Patent Application Publication
(10) Pub. No.: US 2024/0107646 A1
(43) Pub. Date: Mar. 28, 2024

(54) A CONTROLLER FOR UNLEARNING A LEARNT PREFERENCE FOR A LIGHTING SYSTEM AND A METHOD THEREOF

(71) Applicant: SIGNIFY HOLDING B.V., EINDHOVEN (NL)

(72) Inventors: MUHAMMAD MOHSIN SIRAJ, EINDHOVEN (NL); MOHAMMAD FAL SADIKIN, EINDHOVEN (NL)

(21) Appl. No.: 18/274,495

(22) PCT Filed: Jan. 21, 2022
(86) PCT No.: PCT/EP2022/051380

§ 371 Date: Jul. 27, 2023

(30) Foreign Application Priority Data
Jan. 28, 2021 (EP) 21153948.1

(51) Int. Cl. H05B 47/115; G06F 3/01; G06F 3/16; H05B 47/16

(52) U.S. Cl. CPC H05B 47/115; G06F 3/017; G06F 3/167; H05B 47/16

(57) ABSTRACT

A method for unlearning a learnt preference for a lighting system, wherein the method comprises: monitoring one or more feedbacks of a user during a time period, determining whether the one or more feedbacks are related to a light setting of the lighting system or not, assigning a likelihood value to the one or more feedbacks based on the determination, training the machine to learn the user's preference related to the light setting based on the monitored one or more feedbacks, rendering an inferred light setting from the trained machine, receiving a dissatisfaction input from the user indicative of a dissatisfaction level of the user related to the inferred light setting, and if the user's dissatisfaction level exceeds a threshold, removing the one or more feedbacks from the trained machine based on the likelihood value.

### FIELD OF THE INVENTION

The invention relates to a method for unlearning a learnt preference for a lighting system. The invention further relates to a controller, a system and a computer program product for unlearning a learnt preference for a lighting system.

### BACKGROUND

Connected lighting refers to a system of one or more lighting devices which are controlled not by (or not only by) a traditional wired, electrical on-off or dimmer circuit, but rather by using a data communications protocol via a wired or more often wireless connection, e.g., a wired or a wireless network. These connected lighting networks form what is commonly known as the Internet of Things (IoT) or more specifically the Internet of Lighting (IoL). Typically, the lighting devices, or even individual lamps within a lighting device, may each be equipped with a wireless receiver or transceiver for receiving lighting control commands from a lighting control device according to a wireless networking protocol such as Zigbee, Wi-Fi or Bluetooth.

Generally, these (connected) lighting systems are pre-programmed with recommended sets of lighting parameters, which are usually based on manual rules and on sensor coupling. These parameters are selected for achieving a desired light effect on an ‘average’ person in an ‘average’ environment. Machine learning algorithms can be used to optimize light effects for individual users. For learning user preferences for an optimal light effect, such optimization algorithms are based on feedback from the user for each automatic action it takes.

US 2020/007354 A1 discloses method to allow for merchant or third party-controlled adjustment of a physical environment around a user. Such adjustments may be in response to user actions and may create a more immerse experience for the user. Such adjustments may be determined from interaction data received from a user device, with may identify a service provider, a product, or an activity that the user is currently engaging in or is interested in. One or more secondary devices may be identified to be within an area around the user device and one or more environmental rules associated with the service provider, product, or activity may be determined and communicated to the one or more secondary devices to cause the one or more secondary devices to adjust a physical environment of the area proximate the user device.

### SUMMARY OF THE INVENTION

The inventors have realized that for learning user preferences for a lighting system, feedback from the user is of critical importance. Such feedback data is included in the learning algorithm with an implicit assumption that the feedback reflects the response/preference of the user towards the lighting effect. Although, it may happen that a user is engaged in some other activity (e.g., watching tv) and his response (e.g., a voice command saying ‘wow’) may not be feedback towards a lighting effect but a reaction to a tv scene. Thus, this assumption of feedback always reflecting user's response/preference towards the lighting effect may not be true in all cases and thus inclusion of such ‘wrong’ feedback/data points in learning system may severely deteriorate the performance of the learnt system (to represent user preference).

It is therefore an object of the present invention to provide a flexible learning approach which can improve the learning experience.

According to a first aspect, the object is achieved by a method for unlearning a learnt preference for a lighting system, wherein the method comprises: monitoring one or more feedbacks of a user during a time period, determining whether the one or more feedbacks are intended for a light setting of the lighting system in learning the user's lighting preference or not (intended for a light setting of the lighting system in learning the user's lighting preference), assigning a likelihood value to the one or more feedbacks based on the determination, training the machine to learn the user's lighting preference related to the light setting based on the monitored one or more feedbacks, rendering an inferred light setting from the trained machine, and if a dissatisfaction input from the user is received indicative of a dissatisfaction level of the user related to the inferred light setting, and if the user's dissatisfaction level exceeds a threshold, the method further comprises removing at least one of the one or more feedbacks from the trained machine having the lowest likelihood value(s).

The lighting system may comprise one or more lighting devices arranged for illuminating an environment. The method comprises monitoring one or more feedbacks of a user during a time period. In an example, the light settings may change from a first light setting to a second light setting and the time period may start upon such switching of the light settings. In another example, the time period may start upon a user entering the environment and observing the already rendered light settings. The time period may be of a sufficiently long length to capture the feedback from the user.

The method further comprises determining whether the one or more feedbacks are intended for a light setting of the lighting system in learning user's lighting preference or not. The determination may comprise discerning whether the feedback is intended for the lighting system in learning user's lighting preference, or the one or more feedbacks are unrelated to the light setting, e.g., representing a user action or interaction with other systems, other than lighting system or feedback for learning user's other preferences not related to the lighting preference such as preference for a song, movie etc. The determination may be aimed at distinguishing a user's feedback to the lighting system for learning user's lighting preference and other unrelated actions/feedback not related to learning lighting preferences. The determination may be based on determining whether the one or feedback is useful for learning user's lighting preference. The determination may be aimed at detected the ‘wrong’ feedback. The method further comprises assigning a likelihood value to the one or more feedbacks based on the determination.

The method further comprises training the machine to learn user's preference related to the light setting based on the monitored one or more feedbacks. In this example, (almost) all monitored feedback are considered for training the machine. During such training, the likelihood value is not considered for training the machine and the one or more feedbacks are considered equally likely. It is obvious to remove outliers for improving statistical accuracy of training. In statistics, an outlier is a data point that differs significantly from other observations.

The method further comprises rendering an inferred light setting from the trained machine. The inferred light settings are rendered by the one of more lighting devices in the environment. It is understood that the user whose preference is learnt is present to observe the rendered light settings via the one or more light settings. For that the presence of the user may be detected or a signal indicative of the presence of the user may be received and then the light settings may be rendered. When the machine is trained based on (almost) all monitored (equally likely) feedback, i.e., when the user preference is learnt for the lighting system, an inference or a prediction for the user preference can be made. Such an inferred preferred light setting is then rendered e.g., via the one or more lighting devices. The inference can be requested by a user or may be an automatic recommendation.

Based on the inferred light setting, when rendered, a user may provide a dissatisfaction input. The dissatisfaction input is indicative of a dissatisfaction level of the user related to the inferred light setting. If such a dissatisfaction input is received and the user's dissatisfaction level exceeds a threshold, the method further comprises removing at least one of the one or more feedbacks from the trained machine with lowest likelihood values, without training the machine from the scratch. In an example, more than one feedback may be removed at a time with respective lowest values being below a predetermined threshold, wherein the threshold maybe based on user dissatisfaction input. Retraining a machine from scratch requires repeating all the necessary learning steps, as known in the art of machine learning, such as selecting model structure, number of parameters, initial value etc. Removing of the one or more feedback may comprise removing feedback lineage. Since the method removes less likely feedback from the machine without performing retraining from the scratch, the method provides a flexible learning approach which can improve the learning experience. Such an unlearning method based on the likelihood of the feedback provides flexibility as least likely feedback may be removed from the trained machine without the need to retrain the machine from the scratch. The removing step may comprise removing the effect or feedback lineage of at least one of the one or more feedback from the trained machine having the lowest value(s). The effect comprises the effect of the at least one feedback on the prediction or predictive capability of the trained machine, e.g., the prediction from the trained machine to an input may be different with and without at least one feedback. The removal of the at least one feedback is a corrective action after receiving the dissatisfaction input from the user based on the assigned likelihood value.

In an embodiment, the method may further comprise receiving an activity input indicative of an activity of the user; and wherein the determination and/or assigning may be based on the activity of the user during the time period.

In an example, the user may be engaged in an activity, such as watching tv, exercising, talking on phone etc., in such situations the likelihood that the user is attentive to the light settings and thus providing feedback to the light setting is low. In an advanced example, a signal indicative of the user engagement level in the activity may be received and the determination and/or assigning may be based on the user engagement level in the activity of the user during the time period. The user activity and/or engagement level may be determined by any known sensing mechanism, such as using visual sensors (e.g., camera), radiofrequency based sensing, PIR, microphones, wearables such as accelerometers, physiological parameters sensors etc.

In an embodiment, the determination and/or assigning may be based on a time instance, during the time period, at which the one or more feedbacks is monitored.

In an example, when the light settings are changed from a first light setting to a second light setting and if the one or more feedback is monitored after a delay, it may be assumed that the one or more feedbacks may not be related to the second light setting. Therefore, a smaller likelihood value may be assigned. Alternatively, if the feedback is monitored quickly after the change or quickly after when the user enters an environment and observe the already rendered light settings, the probability that he has liked the light setting is high, therefore a higher likelihood value. This embodiment further improves the learning experience.

In an embodiment, the lighting system may comprise one or more lighting devices arranged for illuminating an environment, and wherein the determination and/or the assigning may be based on an operating state of the one or more lighting devices.

The environment may comprise an indoor or an outdoor environment. The operating states of the one or more lighting devices may be the state ON when the one or more lighting devices are powered to provide illumination, state OFF when the one or more lighting devices are not powered, standby state etc. The determination and/or the assigning may be advantageously based on an operating state of the one or more lighting devices because e.g., when the one or more lighting devices are in OFF state for a sufficiently longer time, it is unlikely that one or more feedback is related to the light setting.

In an embodiment, the determination and/or assigning may be based on one or more of: field of view of the user, user's gesture, user's emotions, historical data indicative of the user preference, contextual information about the environment.

The determination and/or assigning may be based on field of view of the user which may determine that whether the user has observed or is observing the light settings. A user's gesture or emotion can also be used. Furthermore, historical data may always be a good indication of user preference and a deviation from such a preference may be assigned a smaller likelihood value. It is to be understood that these characteristics and also in other embodiments disused above may be combined but are not inextricably linked with each other.

In an embodiment, wherein the training of the machine and/or removing of the one or more feedbacks from the trained machine may be performed using machine unlearning algorithms.

Training a model typically requires user feedback (data points) and the model ‘memorize’ all the data points. Given a trained model, machine unlearning assures the model is no longer trained using the feedback (data points) which the user or system elected to erase. In this case, the removal of the feedback and feedback lineage are based on the likelihood of the feedback. Feedback or data lineage comprises the propagation of the feedback data, e.g., the data origin, what happens to it and where it moves over time. The machine unlearning algorithms may comprise Sharded, Isolated, Sliced, and Aggregated training (SISA), statistical query (SQ) learning etc. In an example, only the removal of the one or more feedback is performed using machine unlearning.

In an embodiment, the method may further comprise receiving a presence input indicative of a presence detection of a user; evaluating monitored one or more feedbacks of the user; wherein the one or more feedbacks are positive if no active response has been monitored; training the machine based on the evaluated one or more feedbacks.

In this example, non-obtrusive feedback is considered, wherein no active response from the user while the user is present is considered to be a positive feedback. The user observing the light settings and not changing it indicates the preference of the user to the light setting. The positive feedback represents that the user has preferred the light settings. Such a non-obtrusive feedback mechanism and training a machine, thereafter, advantageously provides both flexible and user-friendly learning of user preference. The presence sensing may be performed via any of the known method in the art, such as passive infrared sensor, active ultrasound sensor, radio-frequency based sensing etc.

In an embodiment, the time period may start upon detecting the user presence, and the time period may be ceased when the presence is no longer detected.

The feedback time period may be defined within the time window after the user is present in the environment. This advantageously provides that the user feedback, with no action as positive feedback, is only considered when the user is present.

In an embodiment, the determination and/or assigning may be based on the confidence of the presence detection of the user.

The user's presence may be detected e.g., by using radio frequency-based presence sensing. The presence of the user may be detected based on a certain confidence level, e.g., 60% confidence, 80% confidence. In this advantageous embodiment, the determination and/or assigning may be based on the confidence of the presence detection of the user.

In an embodiment, the one or more feedbacks may comprise obtrusive feedback, wherein the obtrusive feedback may comprise actuating at least one actuator, by the user, or voice input.

A user may explicitly provide a voice input as feedback such as saying ‘wow’, ‘good’, ‘not good’ etc. Additionally, and/or alternatively, a user may be provided with a user interface to enter a like/dislike button. Such feedback provides flexibility in providing feedback.

In an embodiment, the light setting may comprise any one or more of: color, color temperature, intensity, beam width, beam direction, illumination intensity, and/or other parameters of one or more of light sources of the one or more lighting devices of the lighting system.

In an embodiment, the step of removing the one or more feedbacks from the trained machine based on the likelihood value if a dissatisfaction input from the user is received indicative of a dissatisfaction level of the user related to the inferred light setting, and if the user's dissatisfaction level exceeds a threshold, may be repeated till no dissatisfaction input is received and/or the user's dissatisfaction level does not exceed the threshold.

In this example, the machine learning/unlearning steps may be repeated to provide an iterative learning/unlearning. The one or more feedback may be removed with the likelihood in an ascending order to match user preference.

According to a second aspect, the object is achieved by a controller for unlearning a learnt preference for a lighting system; wherein the controller comprises a processor arranged for executing the steps of method according to the first aspect.

According to a third aspect, the object is achieved by a lighting system for unlearning a learnt preference for a lighting system comprising: one or more lighting devices arranged for illuminating an environment; a controller according to the second aspect.

According to a fourth aspect, the object is achieved by a computer program product comprising instructions which, when the program is executed by a computer, cause the computer to carry out the steps of the method of the first aspect.

It should be understood that the computer program product and the system may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for for unlearning a learnt preference for a lighting system;

FIG. 2 shows schematically and exemplary an embodiment of a controller for for unlearning a learnt preference for a lighting system;

FIG. 3 shows schematically and exemplary a flowchart illustrating an embodiment of a method for for unlearning a learnt preference for a lighting system;

FIG. 4 shows schematically and exemplary an algorithm for machine unlearning.

All the figures are schematic, not necessarily to scale, and generally only show parts which are necessary in order to elucidate the invention, wherein other parts may be omitted or merely suggested.

### DETAILED DESCRIPTION OF EMBODIMENTS

Machine learning provides algorithms to train a machine or model for learning user preference based on the feedback. There is an implicit assumption in all learning methods that the feedback reflects the ‘true’ response/preference of the user related to the learning goal at hand. In case of lighting system, it may happen that a user is engaged in some other activity (e.g., watching tv) and his response (e.g., a voice command saying ‘wow’) is not feedback towards a lighting effect. Instead, such feedback may reflect user's response to his/her activity. Therefore, this assumption may not be true in all cases and inclusion of such ‘wrong’ feedback/data points in learning system may severely deteriorate the performance of the learnt system (to represent user preference).

‘Wrong’ feedback may comprise feedback which was not intended for the light settings but is considered to be feedback in learning lighting preference. A voice input, as discussed above, is a good example of such ‘wrong’ feedback. A gesture/emotion-based feedback may also be taken as a ‘wrong’ feedback, wherein the user may indicate a gesture (or show an emotion) which is not intended for the light settings. Additionally, and/or alternatively, ‘wrong’ feedback may also comprise feedback provided by mistake, e.g., pressing a dislike button instead of a like button, or may be a faulty detection of gesture/emotion. These mistakes are most often not known to the user.

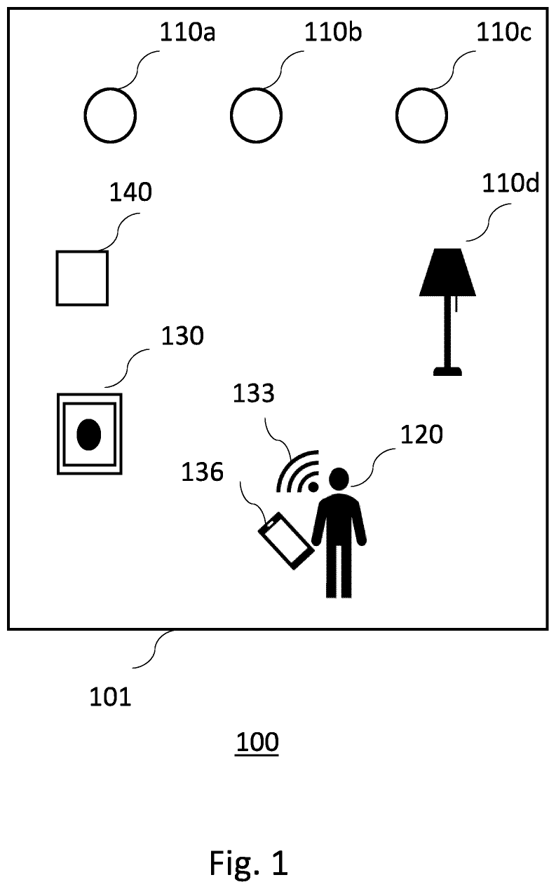

FIG. 1 shows schematically and exemplary an embodiment of a system 100 with lighting device(s) 110a-d for illuminating an environment 101. The environment 101 may be an indoor or outdoor environment, such as office, a factory, a house, a grocery store or a hospital, a sports arena etc. The system 100 exemplary comprises four lighting devices 110a-d. The lighting devices 110a-d may be comprised in a lighting system. The lighting system may be a connected lighting system, e.g., Philips Hue, wherein the lighting devices 110a-d may be connected to an external network, e.g., Internet. A lighting device 110a-d is a device or structure arranged to emit light suitable for illuminating an environment 101, providing or substantially contributing to the illumination on a scale adequate for that purpose. A lighting device 110a-d comprises at least one light source or lamp (not shown), such as an LED-based lamp, gas-discharge lamp or filament bulb, etc., (optionally) with an associated support, casing or other such housing. Each of the lighting devices 110a-d may take any of a variety of forms, e.g., a ceiling mounted lighting device, a wall-mounted lighting device, a wall washer, or a free-standing lighting device (and the lighting devices need not necessarily all be of the same type). In this exemplary figure, the lighting devices 110a-c are ceiling mounted and the lighting device 110d is a free-standing lighting device. The system 100 may contain any number/type of the lighting devices 110a-d.

The lighting devices 110a-d may be controlled based on a set of control parameters to render light effects or light settings. In the context of the application, the light settings are considered as light effects. The light settings the lighting devices 110a-d may comprise one or more of: color, color temperature, intensity, beam width, beam direction, illumination intensity, other parameters of one or more of the light sources (not shown) of the lighting devices 110a-d. The lighting devices 110a-d may be controlled to switch from a first light settings to a second light settings and to render the first and the second light settings. The second light settings may be different from the first light settings such that the difference between the first light settings and the second light settings is perceivable by a user 120. In a simple example, the light setting is a brightness level of the lighting devices 110a-d, for instance, the first light setting is a 30% brightness level, and the second light setting is a 70% brightness level. The second light setting, i.e., 70% brightness level, is determined such that the difference between the first light setting and the second light setting is perceivable by a user 120. For example, the selection of 70% brightness level is based on an ambient light level in the environment 101 such that a difference of 50% in brightness levels is perceivable by a user 120. In another example, the controlling of the lighting devices 110a-d based on the first and/or the second light settings provides no light output.

In an example, the light settings comprise light scenes which can be used to enhance, e.g., entertainment experiences such as audio-visual media, set an ambience and/or a mood of a user 120. For instance, for Philips Hue connected lighting system, the first light setting is an ‘enchanted forest’ light scene, and the second light setting is Go-to-sleep light scene. The first and/or the second light setting may comprise a static light scene. The first and/or the second light settings may comprise a dynamic light scene, wherein the dynamic light scene comprises light effects which change with time.

The user 120 may use a voice input 133 or his/her mobile device 136 to provide one or more feedback which may be monitored. The user 120 may control the lighting devices 110a-d via the voice command 133. The system 100 may further comprise a presence sensing system, which is exemplary a presence sensor 140 in the figure. The system 100 may comprise any number of presence sensors. The presence sensing means may comprise a single device 140 or may comprise a presence sensing system comprising one or more devices arranged for detecting user presence. The presence sensor 140 may be arranged for sensing a signal indicative of a presence of a user 120 and providing a presence input indicative of a presence detection of a user. The presence sensor 140 may be a passive infrared sensor, an active ultrasound sensor or an imaging sensor such as a camera. The user 120 presence may be detected in the environment 101. The system 100 may comprise sensors (not shown) of other modalities such as light sensor for detecting ambient light levels, a temperature sensor, a humidity sensor, a gas sensor such as a CO2 sensor, a particle measurement sensor, and/or an audio sensor. These sensing modalities may be used for monitoring the one or more feedbacks of the user.

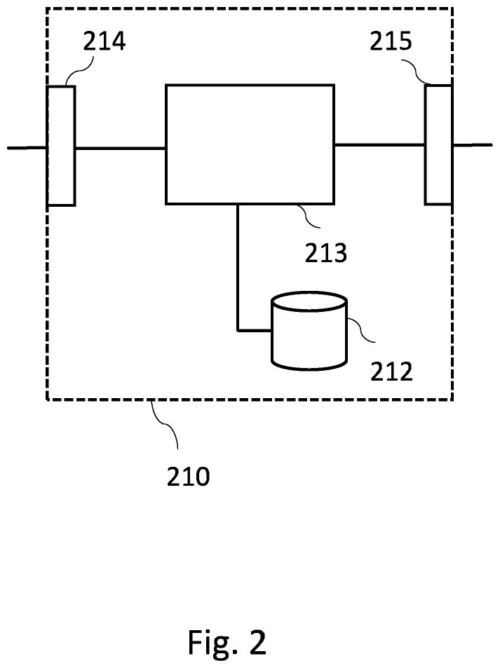

FIG. 2 shows schematically and exemplary an embodiment of a controller 210 for unlearning a learnt preference for a lighting system. The controller 210 may comprise an input unit 214 and an output unit 215. The input 214 and the output 215 units may be comprised in a transceiver (not shown) arranged for receiving (input unit 214) and transmitting (output unit 215) communication signals. The communication signal may comprise control instructions to control the lighting devices 110a-d. The input unit 214 may be arranged for receiving communication signals from the switch 130 and/or from the voice command 133. The input unit 214 may be arranged for receiving the communication signals from the user mobile device 136. The input unit 214 may be arranged for receiving dissatisfaction input from the user, e.g., via a voice message 133, via user mobile device 136 etc. The input unit 214 may be arranged for receiving an activity input indicative of an activity of the user and/or a presence input indicative of a presence detection of a user. The communication signals may comprise control signals. The controller 210 may further comprise a memory 212 which may be arranged for storing communication IDs of the lighting devices 110a-d and/or the sensor 140 etc. The controller 210 may comprise a processor 213 arranged for training the machine and removing the one of more feedbacks. The processor 213 may further be arranged for monitoring one or more feedbacks of a user during a time period, determining whether the one or more feedbacks are related to a light setting of the lighting system or not, assigning a likelihood value to the one or more feedbacks based on the determination.

The controller 210 may be implemented in a unit separate from the lighting devices 110a-d/sensor 140, such as wall panel, desktop computer terminal, or even a portable terminal such as a laptop, tablet, or smartphone. Alternatively, the controller 210 may be incorporated into the same unit as the sensor 140 and/or the same unit as one of the lighting devices 110a-d. Further, the controller 210 may be implemented in the environment 101 or remote from the environment (e.g. on a server); and the controller 210 may be implemented in a single unit or in the form of distributed functionality distributed amongst multiple separate units (e.g. a distributed server comprising multiple server units at one or more geographical sites, or a distributed control function distributed amongst the lighting devices 110a-d or amongst the lighting devices 110a-d and the sensor 140). Furthermore, the controller 210 may be implemented in the form of software stored on a memory (comprising one or more memory devices) and arranged for execution on a processor (comprising one or more processing units), or the controller 210 may be implemented in the form of dedicated hardware circuitry, or configurable or reconfigurable circuitry such as a PGA or FPGA, or any combination of these.

Regarding the various communication involved in implementing the functionality discussed above, to enable the controller 210, for example, to receive presence signal output from the presence sensor 140 and to control the light output of the lighting devices 110a-d, these may be implemented in by any suitable wired and/or wireless means, e.g. by means of a wired network such as an Ethernet network, a DMX network or the Internet; or a wireless network such as a local (short range) RF network, e.g. a Wi-Fi, ZigBee or Bluetooth network; or any combination of these and/or other means.

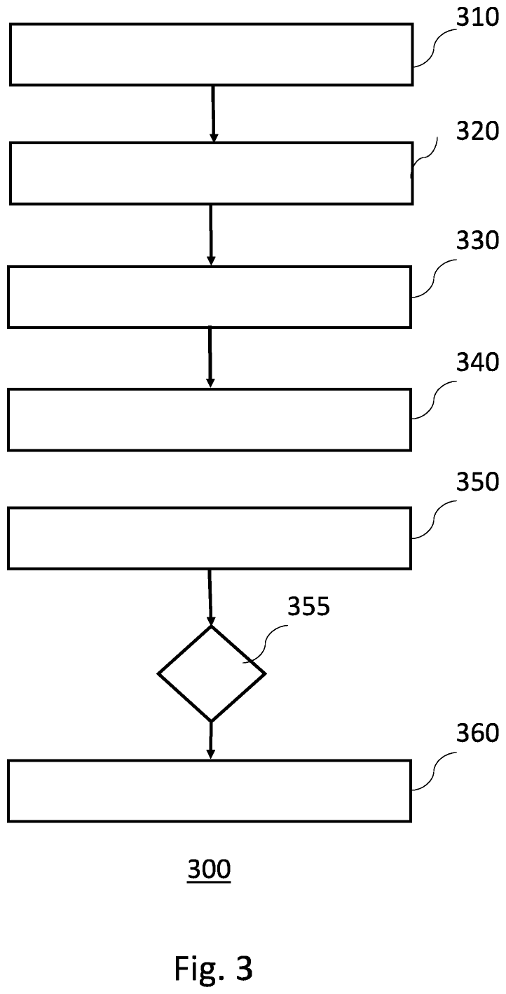

FIG. 3 shows schematically and exemplary a flowchart illustrating an embodiment of a method 300 for for unlearning a learnt preference for a lighting system. The method 300 may comprise monitoring 310 one or more feedbacks of a user during a time period. The monitoring 310 may be based on the type of feedback being monitored. The time period may comprise the time window at which user feedback is expected to be received. The time period may be fixed e.g., by the system or by the user 120 himself or it may be variable depending, e.g., on the light settings, user etc. The time period may also be a learning parameter such that it is adjusted based on the learning. The one or more feedbacks may comprise obtrusive feedback wherein the obtrusive feedback comprises actuating at least one actuator, by the user, or voice input. Other forms of obtrusive feedback known in the art and not mentioned here is not excluded. The one or more feedback may comprise non-obtrusive feedback, wherein the non-obtrusive feedback may be based on gesture/emotions/presence of the user. In an example, a presence input indicative of a presence detection of a user is received and the monitored 310 one or more feedbacks of the user is evaluating; wherein the one or more feedbacks are positive if no active response has been monitored. In such example, the time period may start upon detecting the user presence, and the time period is ceased when the presence is no longer detected.

The method 300 may further comprise determining 320 whether the one or more feedbacks are related to a light setting of the lighting system or not and further comprise assigning 330 a likelihood value to the one or more feedbacks based on the determination. Determining 320 and assigning 330 may be combined in a single method step. The determination 320 and/or assigning 330 may be based on the activity of the user during the time period. The activity of the user may be received via an activity input indicative of an activity of the user. The activity of the user may be determined by visual sensors, wearables, audio sensors etc. known in the art. The determination 320 and/or assigning 330 may be based on the engagement level of the user in the activity. The engagement level may be determined by the same or different sensors as activity level detection which are capable of detecting engagement level such as visual sensors (e.g., cameras), RF sensing etc. The determination 320 and/or assigning 330 may be based on a time instance, during the time period, at which the one or more feedbacks is monitored 310. The time instance is the time at which the one or more feedbacks is received. Furthermore, the determination and/or the assigning may be based on an operating state of the one or more lighting devices. The determination and/or assigning may be based on one or more of: field of view of the user, user's gesture, user's emotions, historical data indicative of the user preference, contextual information about the environment. A field of view is an open observable area a user can see through his or her eyes or via an optical device. The one or more lighting devices may be located in the field of view of the user 120 or at least have illumination in the field of view. A signal indicative of the field of view of the user 120 may be received or the field of view may be determined based on an orientation signal output from an orientation sensor (not shown) which is able to detect the orientation of the user 120. The field of view of the user 120 may be determined based on a user position.

The method 300 may further training 340 the machine to learn user's preference related to the light setting based on the monitored 310 one or more feedbacks. In an example, machine unlearning algorithms such as Sharded, Isolated, Sliced, and Aggregated training (SISA), statistical query (SQ) learning etc (as discussed later) may be used for training 340 the machine. Alternatively, machine learning algorithms may be used for training 340 the machine. For example, supervised learning may be used. Supervised learning is the machine learning task of learning a function or model that maps an input to an output based on an input-output data pairs. It infers a function from a labeled training data set comprising of a set of training data. In supervised learning, each sample in the training data set is a pair consisting of an input (e.g., a vector) and a desired output value. For instance, the evaluated feedback is output, and the second set of control parameters is the input vector. The training data set comprises the output (feedback) and the input (the second set of control parameters). A supervised learning algorithm, such as Support vector machine (SVM), decision tree (random forest) etc., analyzes the training data set and produces an inferred function or model, which can be used for making predictions based on a new data set.

The method 300 may further comprise rendering 350 an inferred light setting from the trained machine. The rendering is performed in the environment 101. The rendering is performed when the user 120 whose preference is learnt is present and is able to observe the rendering of the inferred light settings. Therefore, the presence sensing system 140 may be used to detect the presence of the user 120 and hence trigger the rendering 350 step. In a multi-user environment, the presence sensing system 140 may be arranged to detect the specific user and then render 345 the inferred light settings in the field of view of the specific user 120.

The method 300 may further comprise a condition 355 that if a dissatisfaction input from the user 120 is received indicative of a dissatisfaction level of the user 120 related to the inferred light setting, and if the user's dissatisfaction level exceeds a threshold, the method may further comprise removing 350 the one or more feedbacks from the trained machine based on the likelihood value. The user 120 may be allowed to provide a dissatisfaction input via the voice command 133 or via a user interface, e.g., his/her mobile device 136. The dissatisfaction input may be monitored similar to the monitoring 310 of the one or more feedbacks of the user 120 or it may be a dedicated input such as dedicated voice command, e.g., ‘I don't like the light setting’, and/or a dedicated user interface etc. The dissatisfaction input may be received in a time period. The threshold may be randomly chosen, for instance by the system 100 or by the user 120 e.g., to avoid noise.

If the condition 355 is fulfilled, the method 300 may further comprise removing 360 the one or more feedbacks from the trained machine based on the likelihood value. The likelihood value may comprise probability that the one or more feedback is related to the light settings. The one or more feedbacks with low likelihood value may be removed one by one in an iterative way and the performance of the learnt preference is checked by rendering 350 the inferred light settings. The step may be repeated until no dissatisfaction input is received, or the user's dissatisfaction level does not exceed the threshold. Machine unlearning algorithms may be used to remove 360 the one or more feedbacks from the trained machine based on the likelihood value. Machine unlearning comprises, given a trained machine, unlearning assures the user that the machine is no longer trained using the feedback based on the likelihood. In other words, unlearning guarantees that training on a data point and unlearning it afterwards will produce the same distribution of machines/models that not training on the point at all, in the first place, would have produced. Any known algorithm for machine unlearning can be used.

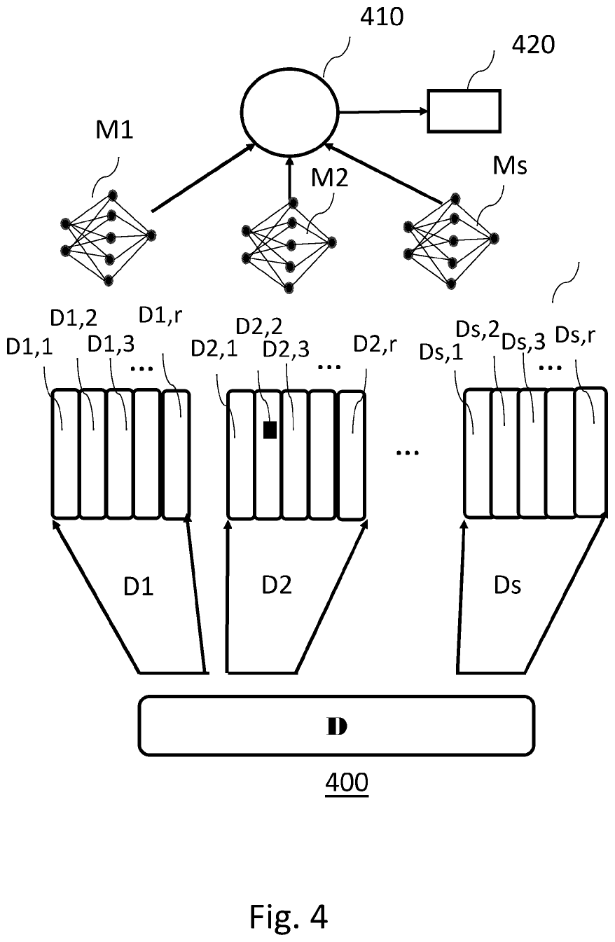

A naive way to have remove feedback is to retrain the machines from scratch. A large computational and time overhead is associated with fully retraining models affected by training data erasure. For example, a different model structure needs to be selected, a number of parameters need to be defined and estimated from the data. Further, training/learning a fully trained machine itself requires high computational resources and may still be not optimal. There are a lot of reiteration involved in selecting the right number of parameters/structure of each data set. Also, training a model (maybe by using machine learning) requires a lot of data points. Removing data points without a strong statistical bases hampered the training process and may result in problems such as overfitting. As a result, the performance of the learnt model is not satisfactory. Therefore, machine unlearning provides algorithms to remove data points through the ability to unlearn. The removal of the feedback requires that particular to-be-removed feedback has zero contribution to the machine. FIG. 4 shows schematically and exemplary an algorithm for machine unlearning. This algorithm is known as Sharded, Isolated, Sliced, and Aggregated training (SISA) in machine unlearning literature. One of the basic principles of machine unlearning is to transforming learning algorithms or the data used by a system into a summation form. To remove a training data sample, only a small number of summations needs to be updated which is asymptotically faster than retraining from scratch. FIG. 4 shows one or more feedbacks (data) as D which is divided into the training data pints D1, D2, . . . Ds into multiple disjoint ‘shred’ such that a training point is included in one shard only; shards partition the data. The training is then performed on each of these shards, to obtain a plurality of trained machine M1, M2, . . . Ms based on the shards D1, D2, . . . Ds. The training on each of the shards limits the influence of a feedback point to the machine that was trained on the shard containing the feedback point. These machines M1, M2, . . . Ms are aggregated to provide an inference out 420. Ideally each shard D1, D2, . . . Ds contains only one feedback/data point but in practice each shard D1, D2, . . . Ds comprises multiple slices D1,1, D1,2 . . . D1,r, D2,1, . . . Ds,r.

For the removal 360 of the at least one of the one or more feedbacks based on the likelihood value, the first step is to identify which one of more feedback is to be removed, e.g., the one with the least likelihood value. In this exemplary figure, the least likely feedback is D2,2. For the removal of such feedback, only the affected machine M2 is retained, whereas the rest of the machine M1, M3, . . . Ms is not trained. This approach avoids retraining the machine completely and also from the scratch.

The method 300 may be executed by computer program code of a computer program product when the computer program product is run on a processing unit of a computing device, such as the processor 210 of the system 100.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g., updates) or extensions for existing programs (e.g., plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method for unlearning a learnt preference for a lighting system, wherein the method comprises:
monitoring one or more feedbacks of a user during a time period,
determining whether the one or more feedbacks are intended for a light setting of the lighting system in learning user's lighting preference or not,
assigning a likelihood value to the one or more feedbacks based on the determination,
training a machine to learn the user's lighting preference related to the light setting based on the monitored one or more feedbacks,
rendering an inferred light setting from the trained machine,
and if a dissatisfaction input from the user is received indicative of a dissatisfaction level of the user related to the inferred light setting, and if the user's dissatisfaction level exceeds a threshold,
the method further comprises:
removing one of the one or more feedbacks from the trained machine having the lowest likelihood value.

2. The method according to claim 1, wherein the method further comprises:
receiving an activity input indicative of an activity of the user; and
wherein the determination and/or assigning are based on the activity of the user during the time period.

3. The method according to claim 1, wherein the determination and/or assigning are based on a time instance, during the time period, at which the one or more feedbacks is monitored.

4. The method according to claim 1, wherein the lighting system comprises one or more lighting devices arranged for illuminating an environment, and wherein the determination and/or the assigning are based on an operating state of the one or more lighting devices.

5. The method according to claim 1, wherein the determination and/or assigning are based on one or more of: field of view of the user, user's gesture, user's emotions, historical data indicative of the user preference, contextual information about the environment.

6. The method according to claim 1, wherein the training of the machine and/or removing of the one or more feedbacks from the trained machine are performed using machine unlearning algorithms.

7. The method according to claim 1, wherein the method further comprises:
receiving a presence input indicative of a presence detection of a user;
evaluating monitored one or more feedbacks of the user; wherein the one or more feedbacks are positive if no active response has been monitored;
training the machine based on the evaluated one or more feedbacks.

8. The method according to claim 7, wherein the time period starts upon detecting the user presence, and the time period is ceased when the presence is no longer detected.

9. The method according to claim 7, wherein the determination and/or assigning are based on the confidence of the presence detection of the user.

10. The method according to claim 1, wherein the one or more feedbacks comprise obtrusive feedback, wherein the obtrusive feedback comprises actuating at least one actuator, by the user, or voice input.

11. The method according to claim 1, wherein the light setting comprises any one or more of: color, color temperature, intensity, beam width, beam direction, illumination intensity, and/or other parameters of one or more of light sources of the one or more lighting devices of the lighting system.

12. The method according to claim 1, wherein the step of removing the one or more feedbacks from the trained machine based on the likelihood value if a dissatisfaction input from the user is received indicative of a dissatisfaction level of the user related to the inferred light setting, and if the user's dissatisfaction level exceeds a threshold, are repeated till no dissatisfaction input is received or the user's dissatisfaction level does not exceed the threshold.

13. A controller for unlearning a learnt preference for a lighting system comprising one or more lighting devices arranged for illuminating an environment; wherein the controller comprises a processor arranged for executing the steps of method according to claim 1.

14. A lighting system for unlearning a learnt preference for a lighting system comprising:
one or more lighting devices arranged for illuminating an environment;
a controller according to claim 13.

15. A computer program product comprising instructions which, when the program is executed by a computer, cause the computer to carry out the steps of the method of claim 1.
